(19) United States
(12) Patent Application Publication
(10) Pub. No.: US 2016/0117796 A1
(43) Pub. Date: Apr. 28, 2016

(54) Content Adaptive Decoder Quality Management

(71) Applicant: Microsoft Technology Licensing, LLC, Redmond, WA (US)

(72) Inventors: Yongjun Wu, Bellevue, WA (US); Radhika Jandhyala, Redmond, WA (US); Shyam Sadhwani, Bellevue, WA (US); Li Li, Redmond, WA (US)

(73) Assignee: MICROSOFT TECHNOLOGY LICENSING, LLC, Redmond, WA (US)

(21) Appl. No.: 14/923,406

(22) Filed: Oct. 26, 2015

Related U.S. Application Data
(60) Provisional application No. 62/069,300, filed on Oct. 27, 2014.

(51) Int. Cl. G06T 1/20; G09G 5/39

(52) U.S. Cl. CPC G06T 1/20; G09G 5/39; G09G 2340/02

(57) ABSTRACT

In one example, a quality management controller of a video processing system may optimize a video recovery action through the selective dropping of video frames. The video processing system may store a compressed video data set in memory. The video processing system may receive a recovery quality indication describing a recovery priority of a user. The video processing system may apply a quality management controller in a video pipeline to execute a video recovery action to retrieve an output data set from the compressed video data set using a video decoder. The quality management controller may select a recovery initiation frame from the compressed video data set to be an initial frame to decompress based upon the recovery quality indication.

### PRIORITY INFORMATION

This application claims priority from U.S. Provisional Patent Application Ser. No. 62/069,300, filed Oct. 27, 2014, the contents of which are incorporated herein by reference in its entirety.

### BACKGROUND

A digital media file player may receive a media data set as a media stream from media source. A media data set may be any form of sequential media, such as an audio data set or a video data set. A digital media file player may compress a media file to improve ease of storage or transmission. The media data set may be compressed using a media compression format, such as a H.264/Advanced Video Coding (AVC) coding format, a High Efficiency Video Coding (HEVC)/H.265 coding format, a Society of Motion Picture & Television Engineers (SMPTE) Video Coding 1 (VC-1) coding format, or a Video Processing 8/9 (VP8/9) coding format. The digital media file player may transform the media data set in a media decoder node. The media decoder node may decompress the media data stream to pass the media data stream to a media renderer. A media renderer may process the media data stream for sequential transmission to the media or display controller hardware.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to optimizing a video recovery action through video frame selection based on video frame type. The video processing system may store a compressed video data set in memory. The video processing system may receive a recovery quality indication describing a recovery priority of a user. The video processing system may apply a quality management controller in a video pipeline to execute a video recovery action to retrieve an output data set from the compressed video data set using a video decoder. The quality management controller may select a recovery initiation frame from the compressed video data set to be an initial frame to decompress based upon the recovery quality indication.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of a computing device.

FIG. 2 illustrates, in a block diagram, one example of a media streaming architecture.

FIG. 3 illustrates, in a block diagram, one example of media processing.

FIG. 4 illustrates, in a block diagram, one example of a media pipeline.

FIG. 5 illustrates, in a block diagram, one example of frame types.

FIG. 6 illustrates, in a block diagram, one example of linked media decoders.

FIG. 7 illustrates, in a flowchart, one example of a method of selecting a recovery initiation frame with a video decoder.

FIG. 8 illustrates, in a flowchart, one example of a method of selecting a recovery initiation frame with a slave decoder.

FIG. 9 illustrates, in a flowchart, one example of a method of media processing optimization.

FIG. 10 illustrates, in a flowchart, one example of a method of bi-predictional frame processing optimization.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a video processing system, a computing device, or a machine-implemented method.

A compressed media data set, such a video data set that has been compressed using a H.264/AVC coding format, a HEVC/H.265 coding format, or some other video compression standard, may be amenable to quality management. A media file player may compress a video data set by, rather than storing an entire video frame, storing a portion of a video frame with a reference to a different video frame in the video data set. A group of picture (GOP) structure may have an intra-predicted frame (I) that does not rely on any other frame, a forward-predictional frame referencing a previous frame (P), and a bi-predictional frame referencing a frame before and after the frame (B). If the video content has a group of picture structure of IPBBPBBPBB . . . , a video decoder may selectively drop a bi-predictional frame without seriously degrading video quality, where the bi-predictional frame is not used for reference. If instead a group of picture structure is IPPPPP . . . , the video data set may have no non-reference target frames past the initial frame. If one frame is dropped due to quality management, the video data set may have artifacts or corruption during a video recovery action, such as the decoding of the future frames. Playback quality may not degrade gracefully by decoder quality management alone. A quality management controller may estimate the percentage of non-reference source frames and output the statistics as an attribute on output samples. A non-reference source frame is a frame that is not used for reference by other frames in compression, such as a bi-predictional frame. An application or a video pipeline may utilize the accumulated statistics to determine whether a video decoder may achieve graceful quality management or not, scalable on a playback frame rate. If not, the video pipeline may drop any decoded frames that have resolved any reference relationships for graceful degraded quality management.

For example, the initially described group of picture structure may have about 66% non-referencing pictures, indicating graceful quality management may be achieved by the video decoder, starting from at least one of a full frame rate, a ⅔ frame rate, a ⅓ frame rate. Selectively dropping the frames may save the decoding resources and downstream resources after decoding. In the second described group of picture structure, the accumulated statistics may indicate graceful quality management may not be achieved by solely the video decoder. The video pipeline or the application may drop the decoded pictures, saving downstream resources after decoding, such as video processing, rendering, and overlay.

When enough resources become available for video playback, the quality management controller may recover from quality management in the video decoder. A user may select a fast recovery with potential corruptions and artifacts by starting recovery on the first available frame. Alternately, the user may sacrifice speed to select a corruption-proof recovery by waiting for a recovery frame with resolved reference relationships. A recovery frame with resolved reference relationships has identified any reference points present in other frames and decoded those reference points.

Thus, in one example, a quality management controller of the video processing system may optimize a video recovery action through video frame selection based on video frame type. The video processing system may store a compressed video data set in memory. The video processing system may receive a recovery quality indication describing a recovery priority of a user. The video processing system may apply a quality management controller in a video pipeline to execute a video recovery action to retrieve an output data set from the compressed video data set using a video decoder. The quality management controller may select a recovery initiation frame from the compressed video data set to be an initial frame to decompress based upon the recovery quality indication. To perform further optimization of the video pipeline, the quality management controller may identify a frame type describing an inter-frame relationship for a recovery frame of the compressed video data set. The quality management controller selectively may drop a recovery frame of the output data set based on the frame type. The video processing system may link a master decoder executing a video recovery action to retrieve an output data set from a compressed video data set to a slave decoder executing an ancillary video recovery action on a subservient video data set to retrieve a supplemental output data set for the output data set.

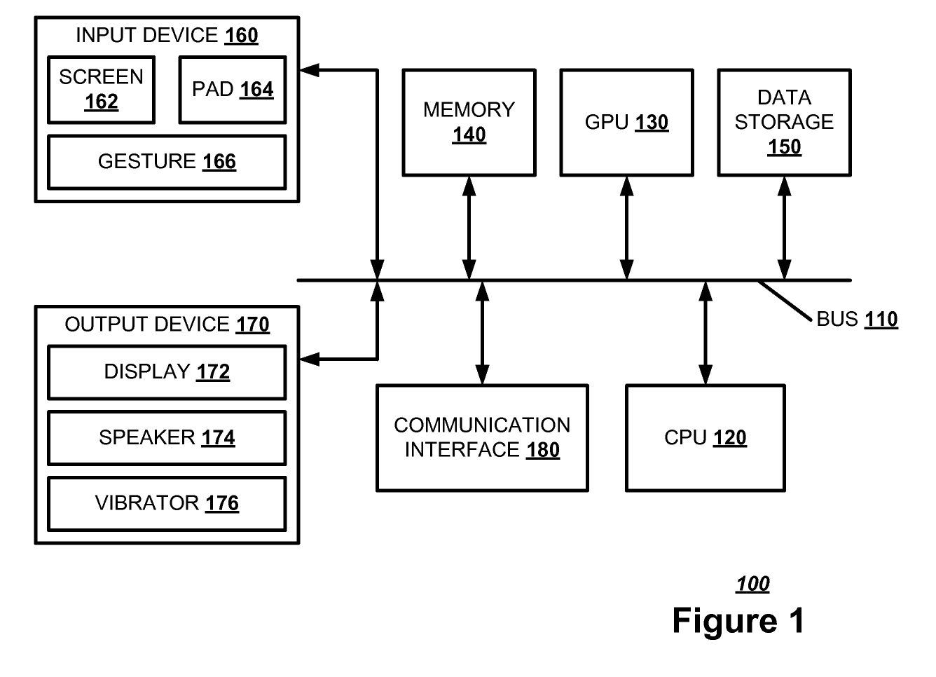

FIG. 1 illustrates a block diagram of an exemplary computing device 100 which may act as video processing system. The computing device 100 may combine one or more of hardware, software, firmware, and system-on-a-chip technology to implement video processing system. The computing device 100 may include a bus 110, a central processing unit (CPU) 120, a graphic processing unit (GPU) 130, a memory 140, a data storage 150, an input device 160, an output device 170, and a communication interface 180. The bus 110, or other component interconnection, may permit communication among the components of the computing device 100.

The central processing unit 120 may include at least one conventional processor or microprocessor that interprets and executes a set of instructions. The graphics processing unit 130 may include at least one processor or microprocessor specialized for processing graphic or video data. The central processing unit may apply a quality management controller in a video pipeline. The quality management controller may execute a video recovery action to retrieve an output data set from the compressed video data set using a video decoder. The quality management controller may select a recovery initiation frame from the compressed video data set to be an initial frame to decompress based upon a recovery quality indication. The recovery quality indication may emphasize a preference for at least one of a fast recovery or a corruption-proof recovery. The quality management controller may designate a first available recovery frame as the recover initiation frame for a fast recovery. The quality management controller may designate a recovery frame with resolved reference relationships with other frames of the compressed video data set as the recovery initiation frame for a corruption-proof recovery.

The quality management controller may set a minimum frame rate describing a fewest frames per time period for the video data set to maintain video quality. The quality management controller may identify a frame type describing an inter-frame relationship for a successive recovery frame of the compressed video data set after the recovery initiation frame. A successive recovery frame is any frame decompressed after the recovery initiation frame. The quality management controller may selectively drop a successive recovery frame of the compressed video data set after the recovery initiation frame based on a frame type. The quality management controller may decode a reference point from a successive recovery frame referred to by a different compressed frame of the video data set. The quality management controller may pass a reference point from a decoded recovery frame of the video data set referred to by a different compressed frame of the compressed video data set to the video pipeline.

The video decoder may be a master decoder linked to a slave decoder executing an ancillary video recovery action on a subservient video data set to retrieve a supplemental output data set for the output data set. The master decoder may alert the slave decoder to the recovery initiation frame.

The memory 140 may be a random access memory (RAM) or another type of dynamic data storage that stores information and instructions for execution by the central processing unit 120. The memory 140 may also store temporary variables or other intermediate information used during execution of instructions by the central processing unit 120. The memory 140 may store for use by the central processing unit 120 or the graphical processing unit 130 a compressed video data set received via the communication interface 180 or stored in the data storage 150.

The data storage 150 may include a conventional ROM device or another type of static data storage that stores static information and instructions for the central processing unit 120. The data storage 150 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 150 may store a set of instructions detailing a method that when executed by one or more processors cause the one or more processors to perform the method. The data storage 150 may store the compressed media data set. The data storage 150 may also be a database or a database interface for storing a compressed media data set.

The input device 160 may include one or more conventional mechanisms that permit a user to input information to the computing device 100, such as a keyboard, a mouse, a voice recognition device, a microphone, a headset, a touch screen 162, a touch pad 164, a gesture recognition device 166, etc. The input device 160 may receive a recovery quality indication describing a recovery priority of a user for at least one of a fast recovery or a corruption proof recovery. The output device 170 may include one or more conventional mechanisms that output information to the user, including a display screen 172, a printer, one or more speakers 174, a headset, a vibrator 176, or a medium, such as a memory, or a magnetic or optical disk and a corresponding disk drive.

The communication interface 180 may include any transceiver-like mechanism that enables computing device 100 to communicate with other devices or networks. The communication interface 180 may include a network interface or a transceiver interface. The communication interface 180 may be a wireless, wired, or optical interface. The communication interface 180 may download a compressed media data set.

The computing device 100 may perform such functions in response to central processing unit 120 executing sequences of instructions contained in a computer-readable medium, such as, for example, the memory 140, a magnetic disk, or an optical disk. Such instructions may be read into the memory 140 from another computer-readable medium, such as the data storage 150, or from a separate device via the communication interface 180.

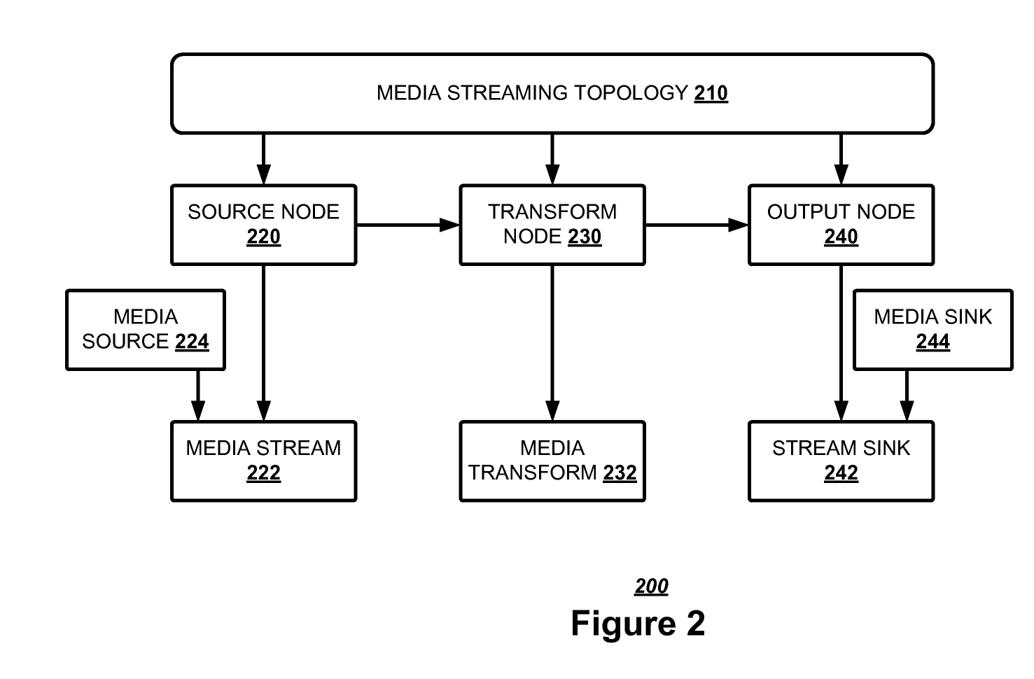

FIG. 2 illustrates, in a block diagram, one example of a media streaming architecture 200. A media streaming architecture 200 may be implemented by an application executed by the central processing unit 120. The application may represent the media streaming architecture as a media streaming topology 210. A media streaming topology 210 is an object that represents a data flow in a media streaming pipeline. The media streaming topology 210 may represent each processing component in the media streaming pipeline as a node. The media streaming pipeline may receive the media data set in a source node 220 to pass to a transform node 230 before outputting the processed media data set as an output node 240. The source node 220 may represent a media stream 222 from a media source 224. A media source 224 is a data object that generates media data from an external source, such as the media stream 222. The transform node 230 may represent a media transform 232, such as a media decoder. The output node 240 may represent a stream sink 242 on a media sink 244, such as a media renderer.

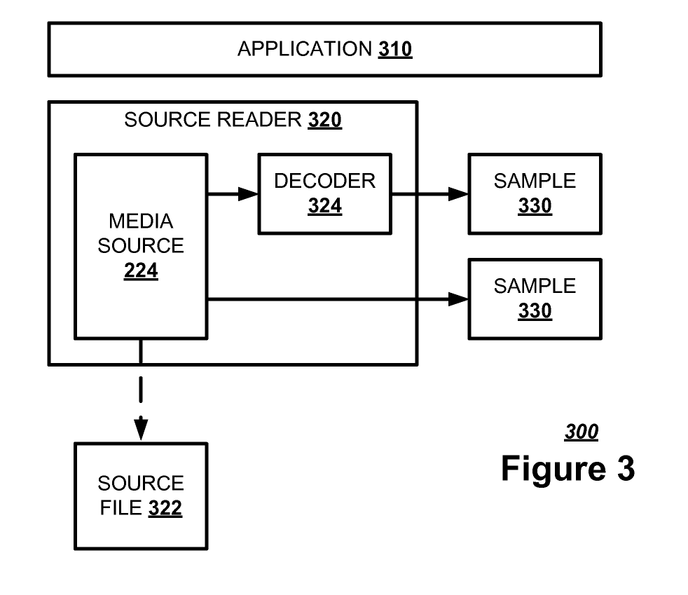

FIG. 3 illustrates, in a block diagram, one example of media processing 300. A media presentation application 310 may implement a source reader 320 to manage any method calls to a media source 224. The media source 224 may be a media data file 322 or a media data stream 222 received over a network. The source reader 320 may deliver a media data sample 330, either directly from the media source 224 or, if the media source has compressed media data, by implementing a media decoder 324 to decompress the media data.

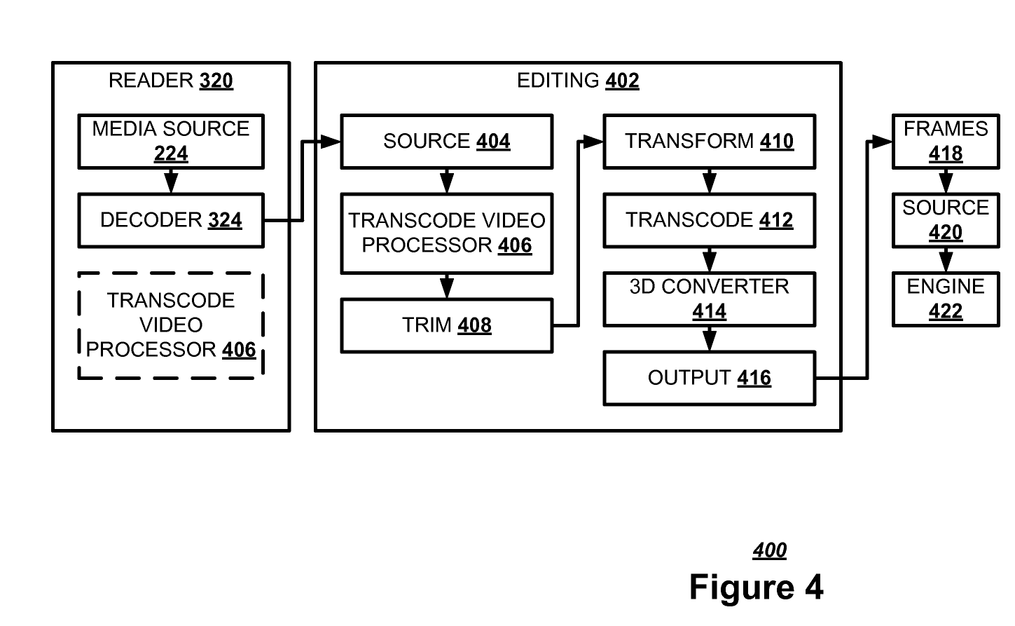

FIG. 4 illustrates, in a block diagram, one example of a media pipeline 400. As described previously, the source reader 320 may decompress media data from a media source 224 with a media decoder 324. The media data set may be a video data set, organized as a clip. The media decoder 324 may provide decompressed video data to an editing frame server 402 via a source processing node 404. An editing frame server 402 is an editing application that separates video data into frames. A source processing node 404 is an input for the editing frame server 402. The source processing node 404 may provide the video data to a transcode video processor 406. The transcode video processor 406 may perform video processing, such as color conversion, scaling, frame rate conversion, rotation, and other effects. The transcode video processor 406 may execute the video processing in the source reader 320 or the editing frame server 402. After the video processing, a trim processing node 408 may trim the video clip. A media transform node 410 may provide further rendering. A transcode node 412 may translate the video data for export. A three dimensional converter node 414 may add any three dimensional effects. An output node 416 may export the video data.

The editing frame server 402 may export the video data set as a series of video frames 418 to a media source interface 420 for access by a media engine 422. A media engine 424 may provide the video frames to the media presentation application 310 for presentation to a user.

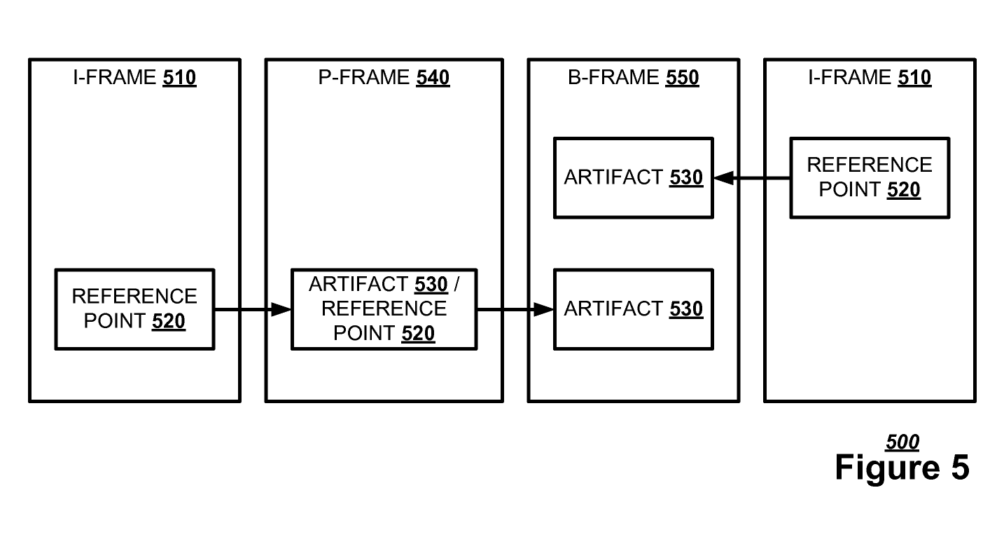

For purposes of executing a corruption-proof recovery, a video pipeline may use a non-reference target frame or a reference target frame once the reference relationships have been resolved. FIG. 5 illustrates, in a block diagram, one example of frame types 500. A video frame may be an intra-predicted frame (I-Frame) 510. An intra-predicted frame 510 is a non-reference target frame that does not rely on data in any other frame for decompression data. An intra-predicted frame 510 provides little compression in exchange for little to no loss of data.

Alternately, a video frame may be a reference target frame. A reference target frame refers to a reference point 520 in a different frame when compressed, rather than storing the data contained at the reference point 520 directly. By referring to the reference point 520, the reference target frame may allow for greater compression by allowing for some loss of data. The reference point 520 may create an artifact 530 in the reference target frame when the frame containing the reference point 520 is missing from the data stream. A reference point 520 may propagate through multiple frames. A reference target frame may be a forward-predictional frame (P-Frame) 540, which refers to a reference point 520 in a previous frame. Alternately, a reference target frame may be a bi-predictional frame (B-Frame) 550, which refers to reference points 520 in both a previous frame and a successive frame.

For purposes of selecting a successive recovery frame, a video frame may be a reference source frame or a non-reference source frame. A reference source frame provides a reference point 520 for a reference target frame. Typically, a reference source frame may be an intra-predicted frame 510 or a forward-predicted frame 540. A non-reference source frame provides no reference points 520 to any reference target frames. A reference source frame may be an intra-predicted frame 510, a forward-predicted frame 540, or a bi-predictional frame 550.

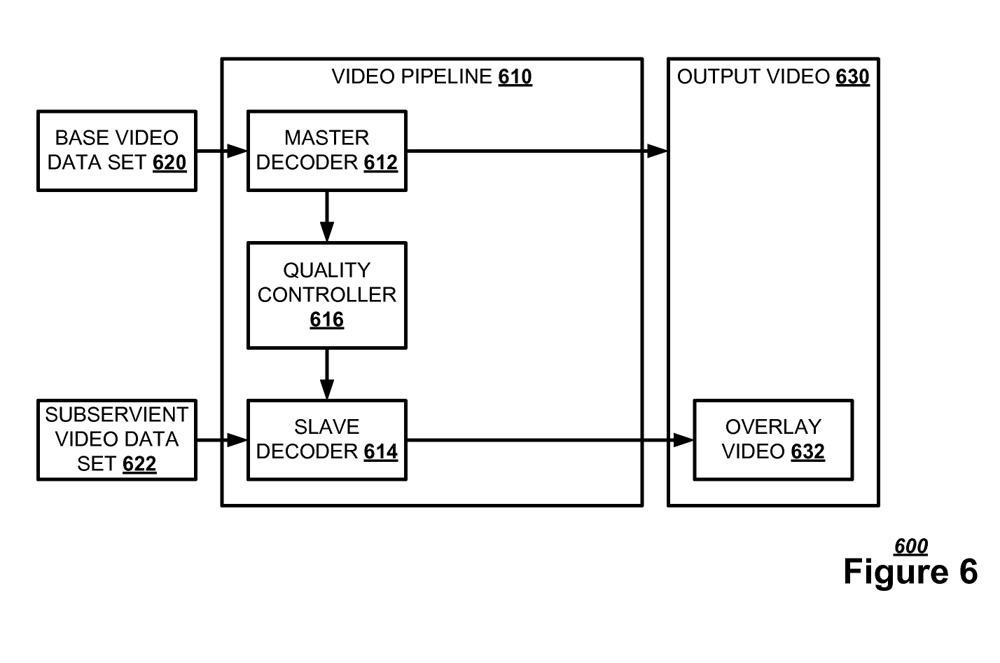

A video data set may have multiple streams. For example, a video data set may have a base video data set with a set of sub-tides rendered as a separate video stream. Each video data set may have a video pipeline rendering that video stream. Each video pipeline may be linked to the other video pipeline. FIG. 6 illustrates, in a block diagram, one example of linked media decoder system 600. A video pipeline 610 may process a base video data set 620 to produce an output video 630. The video pipeline 610 may have a master decoder 612 to decompress the base video data set 620. The video pipeline 610 may process the base video data set 620 for sequential transmission to the video hardware as an output video 630. Additionally, a slave decoder 614 in the video pipeline 610 may decompress a subservient video data set 622. The video pipeline 610 may process the subservient video data set 622 for sequential transmission to the video hardware as an overlay video 632, such as a set of sub-tides.

A quality management controller 616 resident in the video pipeline 610 may execute a video recovery action on the base video data set 620. A video recovery action is an action to retrieve an output video from a compressed video data set, such as decoding or decompressing the compressed video data set. The quality management controller 616 may execute an ancillary video recovery action on the subservient video data set 622 using the slave decoder 614. The quality management controller 616 may receive a recovery quality indication from a user indicating a recovery priority. The quality management controller 616 may select a recovery initiation frame from the video data set based upon the recovery quality indication. A recovery initiation frame is the initial frame decompressed in a recovery action. If the user emphasizes a fast recovery, the quality management controller 616 may designate the first available recovery frame as a recovery initiation frame. If the first available recovery frame is a reference target frame, the recovery initiation frame may be missing reference points that result in artifacts appearing. If the user emphasizes a corruption-proof recovery, the quality management controller 616 may designate a non-reference target frame as a recovery initiation frame. The recovery initiation frame may then have no missing reference points that result in artifacts appearing.

The quality management controller 616 may select a recovery initiation frame for the master decoder 612. The master decoder 612 may execute a video recovery action on the base video data set 620 at the recovery initiation frame producing a video frame with a frame timestamp. The video pipeline 610 may link master decoder 612 to the slave decoder 614. The video pipeline may alert the slave decoder 642 to the recovery initiation frame by sending a frame timestamp to the slave decoder. The slave decoder 614 may execute an ancillary video recovery action on the subservient video data set 622 based on the recovery initiation frame identified by the master decoder 612 using the frame timestamp.

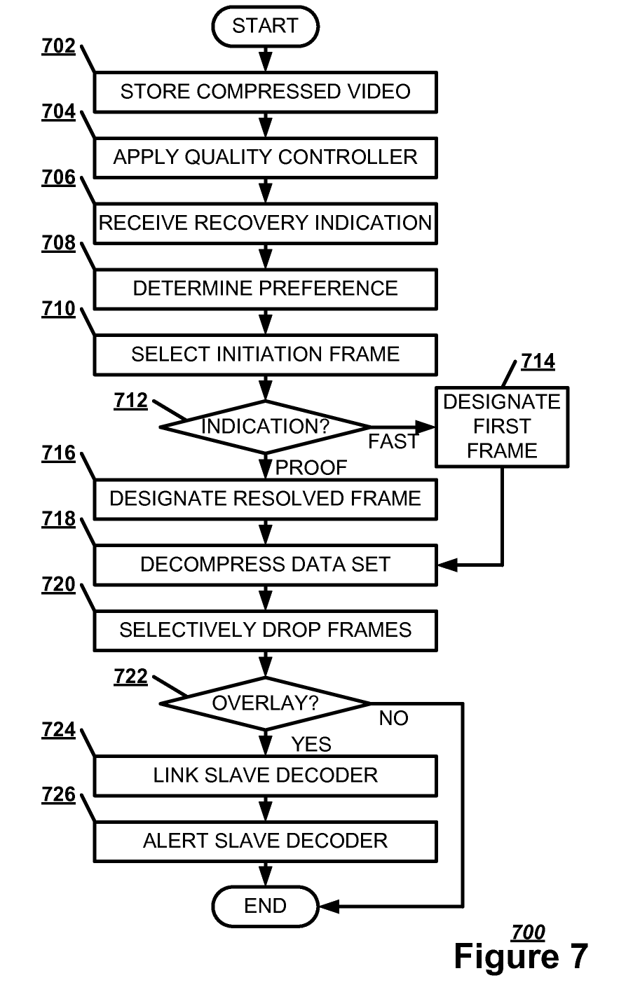

FIG. 7 illustrates, in a flowchart, one example of a method 700 of selecting a recovery initiation frame with a video decoder. The video pipeline, such as video pipeline 610, may store a compressed video data set in memory, such as memory 140 (Block 702). The video pipeline may apply a quality management controller, such as quality management controller 616, to execute a video recovery action to retrieve an output data set from the compressed video data set using a video decoder (Block 704). The quality management controller may receive a recovery quality indication describing a recovery priority of a user (Block 706). The quality management controller may determine whether the recovery quality indication emphasizes a preference for at least one of a fast recovery and a corruption-proof recovery (Block 708). The quality management controller may select a recovery initiation frame from the compressed video data set to be an initial frame to decompress based upon the recovery quality indication (Block 710). If the recovery quality indication emphasizes a fast recovery (Block 712), the quality management controller may designate a first available recovery frame as the recovery initiation frame for a fast recovery (Block 714). If the recovery quality indication emphasizes a corruption-proof recovery (Block 712), the quality management controller may designate a recovery frame with resolved reference relationships with other frames of the compressed video data set as the recovery initiation frame for a corruption-proof recovery (Block 716). The quality management controller may begin decompressing the video data set at the recovery initiation frame (Block 718). The quality management controller may optimize performance by selectively dropping recovery frames, such as successive recovery frames of the compressed video data set after the recovery initiation frame (Block 720). If a subservient video data set is overlaid on the video data set (Block 722), the quality management controller may link the video decoder as a master decoder to a slave decoder executing an ancillary video recovery action on a subservient video data set to retrieve a supplemental output data set for the output data set (Block 724). The quality management controller may alert the slave decoder executing an ancillary video recovery action on a subservient video data set to the recovery initiation frame by sending a frame timestamp for the recovery initiation frame from the master decoder to the slave decoder (Block 726).

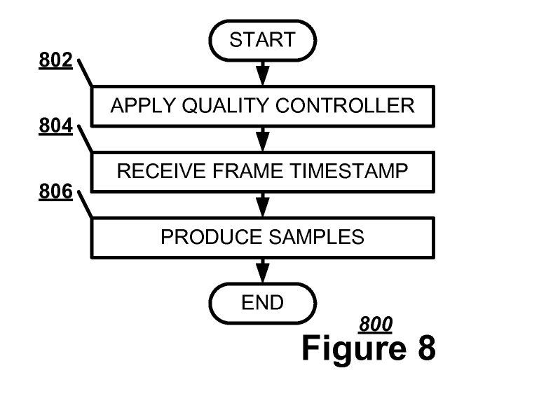

FIG. 8 illustrates, in a flowchart, one example of a method 800 of selecting a recovery initiation frame with a slave decoder, such as slave decoder 614. The video pipeline, such as video pipeline 610, may apply a quality management controller, such as quality management controller 616, to execute an ancillary video recovery action with a slave decoder on a subservient video data set, such as subservient video data set 622 (Block 802). The slave decoder may receive a frame timestamp for a recovery initiation frame from a master decoder, such as master decoder 612 (Block 804). The slave decoder may then produce samples as close to the frame timestamp as possible (Block 806).

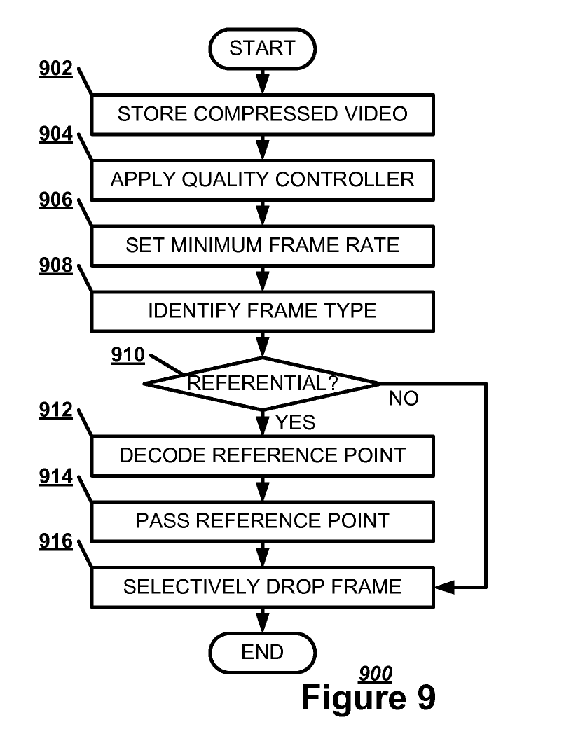

The quality management controller may further optimize the performance of the video decoder based on the frame type of frames of the video data set. FIG. 9 illustrates, in a flowchart, one example of a method 900 of media processing optimization. The video pipeline, such as video pipeline 610, may store a compressed video data set in memory, such as memory 140 (Block 902). The video pipeline may apply a quality management controller, such as quality management controller 616, to retrieve an output data set from the compressed video data set using a video decoder (Block 904). The quality management controller may set a minimum frame rate describing a fewest frames per time period for the output data set to maintain video quality (Block 906). The quality management controller may identify a frame type describing an inter-frame relationship for a recovery frame, such as a pre-initiation recovery frame or a successive recovery frame, of the compressed video data set, determining whether the recovery frame is a reference source frame or a non-reference source frame (Block 908). If the recovery frame is a reference source frame having a reference point used by other recovery frames (Block 910), the quality management controller may decode a reference point from the recovery frame referred to by a different compressed frame of the compressed video data set (Block 912). The quality management controller may pass a reference point from a decoded recovery frame of the compressed video data set referred to by a different compressed frame of the compressed video data set to the video pipeline (Block 914). The quality management controller selectively may drop the recovery frame of the output data set based on a frame type (Block 916).

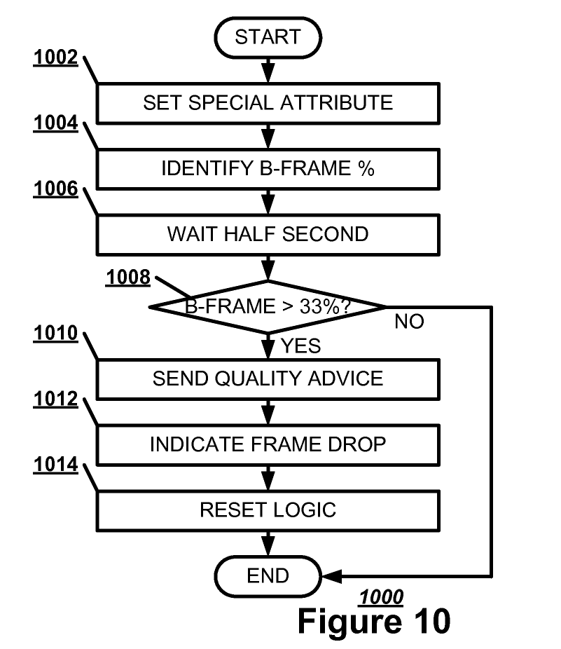

Specifically, the quality management controller may emphasize dropping non-reference source frames, such as bi-predictional frames. FIG. 10 illustrates, in a flowchart, one example of a method 1000 of bi-predictional frame processing optimization. A media engine, such as media engine 424, may set a special attribute on the video decoder to enable setting a bi-predictional frame attribute on a decoded samples (Block 1002). The video decoder may set the attributes on an output sample to indicate the percentage of frames that are bi-predictional or non-reference frames (Block 1004). The media engine may wait for a half second for a sample with a bi-predictional frame attribute (Block 1006). If the media engine identifies a sample having greater than 33% of the frames are bi-predictional or non-reference frames (Block 1008), the media engine may send quality advice to the video decoder (Block 1010). The media engine may indicate to the video decoder to drop decoded frames for better quality, with the video decoder deciding which frames and how many frames to drop (Block 1012). The media engine may reset the logic at the clip boundary (Block 1014).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A video processing system, comprising:
memory configured to store a compressed video data set;
an input device configured to receive a recovery quality indication describing a recovery priority of a user for at least one of a fast recovery and a corruption proof recovery; and
a central processing unit having at least one processor configured to apply a quality management controller in a video pipeline to execute a video recovery action to retrieve an output data set from the compressed video data set using a video decoder and further configured to have the quality management controller select a recovery initiation frame from the compressed video data set to be an initial frame to decompress based upon the recovery quality indication.

2. The video processing system of claim 1, wherein the quality management controller is configured to designate a first available recovery frame as the recovery initiation frame for the fast recovery.

3. The video processing system of claim 1, wherein the quality management controller is configured to designate a recovery frame with resolved reference relationships with other frames of the compressed video data set as the recovery initiation frame for the corruption-proof recovery.

4. The video processing system of claim 1, wherein the quality management controller is configured to set a minimum frame rate describing a fewest frames per time period for the video data set to maintain video quality.

5. The video processing system of claim 1, wherein the quality management controller is configured to identify a frame type describing an inter-frame relationship for a successive recovery frame of the compressed video data set after the recovery initiation frame.

6. The video processing system of claim 1, wherein the quality management controller is configured to selectively drop a successive recovery frame of the compressed video data set after the recovery initiation frame based on a frame type.

7. The video processing system of claim 1, wherein the quality management controller is configured to decode a reference point from a successive recovery frame referred to by a different compressed frame of the video data set.

8. The video processing system of claim 1, wherein the quality management controller is configured to pass a reference point from a decoded recovery frame of the video data set referred to by a different compressed frame of the compressed video data set to the video pipeline.

9. The video processing system of claim 1, wherein the video decoder is a master decoder linked to a slave decoder executing an ancillary video recovery action on a subservient video data set to retrieve a supplemental output data set for the output data set.

10. The video processing system of claim 9, wherein the master decoder is configured to alert the slave decoder to the recovery initiation frame.

11. A computing device, having a memory to store a compressed video data set, the computing device configured to apply a quality management controller in a video pipeline to a video recovery action to retrieve an output data set from the compressed video data set using a video decoder, the computing device further configured to identify a frame type describing an inter-frame relationship for a recovery frame of the compressed video data set, and the computing device also configured to selectively drop a recovery frame of the output data set based on the frame type.

12. The computing device of claim 11, wherein the computing device is further configured to set a minimum frame rate describing a fewest frames per time period for the output data set to maintain video quality.

13. The computing device of claim 11, wherein the computing device is further configured to decode a reference point from the recovery frame referred to by a different compressed frame of the compressed video data set.

14. The computing device of claim 11, wherein the computing device is further configured to pass a reference point from a decoded recovery frame of the compressed video data set referred to by a different compressed frame of the compressed video data set to the video pipeline.

15. The computing device of claim 11, wherein the computing device is further configured to receive a recovery quality indication describing a recovery priority of a user.

16. The computing device of claim 11, wherein the computing device is further configured to select a recovery initiation frame from the compressed video data set to be an initial frame to decompress.

17. The computing device of claim 11, wherein the computing device is further configured to link the video decoder as a master decoder to a slave decoder executing an ancillary video recovery action on a subservient video data set to retrieve a supplemental output data set for the output data set.

18. The computing device of claim 17, wherein the computing device is further configured to alert the slave decoder to a recovery initiation frame from the compressed video data set to be an initial frame to decompress.

19. A machine-implemented method, comprising:
applying a quality management controller in a video pipeline to a video recovery action to retrieve an output data set from a compressed video data set using a master decoder;
linking the master decoder to a slave decoder executing an ancillary video recovery action on a subservient video data set to retrieve a supplemental output data set for the output data set;
selecting, with the quality management controller, a recovery initiation frame from the compressed video data set to be an initial frame to decompress; and
alerting, with the quality management controller, the slave decoder to the recovery initiation frame.

20. The video processing system of claim 19, further comprising:
receiving, in the quality management controller, a recovery quality indication describing a recovery priority of a user.
